(19) United States
(12) Patent Application Publication
(10) Pub. No.: US 2020/0106140 A1
(43) Pub. Date: Apr. 2, 2020

(54) MEASUREMENT LID FOR BATTERY CELL OF AN ELECTRIC VEHICLE

(71) Applicant: SF Motors, Inc., Santa Clara, CA (US)

(72) Inventors: Scott Quinlan Freeman Monismith, Santa Clara, CA (US); Jeremy Andrew Elsberry, Santa Clara, CA (US); Derek Nathan Wong, Santa Clara, CA (US); Ying Liu, Santa Clara, CA (US); Yifan Tang, Santa Clara, CA (US)

(21) Appl. No.: 16/148,548

(22) Filed: Oct. 1, 2018

(51) Int. Cl. H01M 10/48; H01M 2/04; B60L 11/18

(52) U.S. Cl. CPC H01M 10/486; B60L 11/1879; H01M 2/043; H01M 2/046

(57) ABSTRACT

Provided herein is a battery cell of a battery pack to power an electric vehicle. The battery cell can include a lid having an extended region that includes a threaded hole to receive at least one sensor element to measure properties of the battery cell or a battery pack. The battery cell can include a housing having a first end and a second end. An electrolyte can be disposed in an inner region defined by the housing. The lid can couple with a first end of the housing and include a base portion coupled with the first end of the housing. The extended portion can couple with the base portion. The extended portion can include an inner cavity and the threaded hole can form an opening of the inner cavity. The sensor element can couple with the threaded hole and can be disposed within the inner cavity.

### BACKGROUND

Batteries can include electrochemical materials to supply electrical power to electrical components connected thereto. Such batteries can provide electrical energy to electrical systems.

### SUMMARY

Systems and methods described herein relates to a battery cell of a battery pack of an electric vehicle. The battery cell can include a lid having an extended region that includes a threaded hole to receive at least one sensor element or at least one sensor wire to measure properties of the battery cell. For example, a sensor element can couple with the threaded hole and be disposed within an inner cavity to measure properties of different components (e.g., electrolyte) of the battery cell. The properties can include, but not limited to, a composition value, a flow value, a pressure value or a temperature value. A sensor wire can be disposed within the threaded hole of the extended region and couple with a sensor element disposed within the battery cell. For example, a first end of the sensor wire can couple with a sensor element disposed within an inner region of the housing of the battery cell such that the sensor element is disposed adjacent to the electrolyte. A middle portion of the sensor wire can include a threaded outer surface to couple and secure the sensor wire with the threaded hole of the extended region. A connector (e.g., brass fitting) may be used to couple the middle portion of the sensor wire with the threaded hole of the extended region. For example, the connector can have a threaded outer surface to couple with the threaded inner hole of the extended region. The connector can have an orifice sized to receive the sensor wire and form a seal for the battery cell. A second end of the sensor wire can extend out of the extended region (or top hat) of the lid. For example, the second end of the sensor wire can extend out of the extended region to couple with a battery monitoring unit and provide measurements corresponding to properties of the battery cell. Thus, the lid as described herein can take and provide measurements for properties of components of the battery cell in a non-invasive manner. For example, the sensor element, sensor device or sensor wire can couple with the battery cell through the extended region of the lid. Thus, measurements of internal variables or components of the battery cell can be taken without puncturing a hole through the battery cell, drilling a hole through the battery cell, or other forms of damaging the integrity of the battery cell.

At least one aspect is directed to a battery cell of a battery pack to power an electric vehicle. The battery cell can include a housing having a first end and a second end. The housing can define an inner region. An electrolyte can be disposed in the inner region defined by the housing. A lid can couple with a first end of the housing. The lid can include a base portion coupled with the first end of the housing. An extended portion can couple with the base portion. The extended portion can include an inner cavity. The extended portion can include a threaded hole forming an opening of the inner cavity. A sensor element can couple with the threaded hole of the extended portion. The sensor element can be disposed within the inner cavity of the extended portion.

At least one aspect is directed to a method of providing a battery cell of a battery pack to power an electric vehicle. The method can include providing a battery pack having a battery cell. The battery cell can include a housing that include a first end and a second end and defines an inner region. The method can include coupling a lid with the first end of the housing. The lid can include a base portion and an extended portion. The method can include disposing an electrolyte within the inner region defined by the housing. The method can include coupling a sensor element with a threaded hole of the extended portion of the lid to form a hermetic seal and a fluid resistant seal for the battery cell. The sensor element can be disposed within the inner cavity of the extended portion.

At least one aspect is directed to a method. The method can provide a battery cell of a battery pack of an electric vehicle. The battery cell can include a housing having a first end and a second end. The housing can define an inner region. An electrolyte can be disposed in the inner region defined by the housing. A lid can couple with a first end of the housing. The lid can include a base portion coupled with the first end of the housing. An extended portion can couple with the base portion. The extended portion can include an inner cavity. The extended portion can include a threaded hole forming an opening of the inner cavity. A sensor element can couple with the threaded hole of the extended portion. The sensor element can be disposed within the inner cavity of the extended portion.

At least one aspect is directed to an electric vehicle. The electric vehicle can include a battery cell of a battery pack of an electric vehicle. The battery cell can include a housing having a first end and a second end. The housing can define an inner region. An electrolyte can be disposed in the inner region defined by the housing. A lid can couple with a first end of the housing. The lid can include a base portion coupled with the first end of the housing. An extended portion can couple with the base portion. The extended portion can include an inner cavity. The extended portion can include a threaded hole forming an opening of the inner cavity. A sensor element can couple with the threaded hole of the extended portion. The sensor element can be disposed within the inner cavity of the extended portion.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram depicting a cross-sectional view of an example battery cell for a battery pack in an electric vehicle having at least one sensor element, according to an illustrative implementation;

FIG. 2 is a block diagram depicting a cross-sectional view of an example battery cell for a battery pack in an electric vehicle having a sensor coupled with a sensor wire, according to an illustrative implementation;

FIG. 3 is an exploded side view of a battery cell for a battery pack in an electric vehicle showing the lid separated from the housing of the battery cell, according to an illustrative implementation;

FIG. 4 is a side view of a battery cell for a battery pack in an electric vehicle showing the lid coupled with the housing of the battery cell, according to an illustrative implementation;

FIG. 5 is a top view of a lid of a battery cell for a battery pack in an electric vehicle, according to an illustrative implementation;

FIG. 6 is a block diagram depicting a cross-sectional view of an example battery pack for holding battery cells in an electric vehicle;

FIG. 7 is a block diagram depicting a cross-sectional view of an example electric vehicle installed with a battery pack;

FIG. 8 is a flow diagram depicting an example method of providing a battery cell of a battery pack to power an electric vehicles; and

FIG. 9 is a flow diagram depicting an example method of providing battery cells for battery packs for electric vehicles.

### DETAILED DESCRIPTION

Following below are more detailed descriptions of various concepts related to, and implementations of battery cells for battery packs in electric vehicles. The various concepts introduced above and discussed in greater detail below can be implemented in any of numerous ways.

Systems and methods described herein relate to a battery cell of a battery pack of an electric vehicle having at least one sensor element to obtain measurements of the battery cell or battery pack. The battery cell can include a lid having a base portion and an extended portion (e.g., top hat feature). The extended portion can include an inner cavity and a threaded hole to allow for the insertion of at least one sensor element, such as but not limited to, a sensor or a sensor wire. For example, the sensor element can couple with the threaded hole to secure the sensor element within the inner cavity of the extended portion or within the housing of the battery cell. A first end of the sensor element can extend out of the respective battery cell to couple with a battery monitoring unit to provide readings and measurements. A second end of the sensor element can couple a sensor within the battery cell. The sensor element can include, but not limited to, a transducer, a thermocouple, a composition sensor, or a flow meter. Thus, the battery monitoring unit can collect data such as, but not limited to, pressure data, temperature data, composition data (e.g., composition of components of an electrolyte), or flow data. The properties (e.g., height) of the extended portion can be selected to allow the lid to be coupled with or crimped onto the respective battery cell to using commercially available grooving and crimping equipment. The lid having an extended portion and at least one sensor element provides for the battery monitoring unit to couple with the battery cell 100 to take and provide measurements for properties of components of the battery cell 100 or battery pack 605 in a non-invasive manner. Thus, measurements of internal variables or components of one or more battery cells or a battery pack can be taken without damaging the integrity of the battery cell.

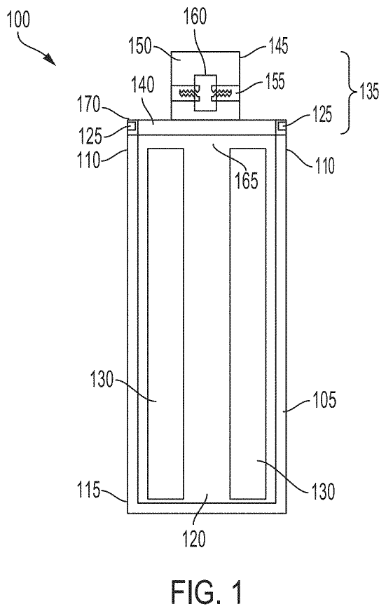

FIG. 1, among others, depicts a cross-sectional view of a battery cell 100 for a battery pack in an electric vehicle. The battery cell 100 can provide energy or store energy for an electric vehicle. For example, the battery cell 100 can be included in a battery pack used to power an electric vehicle. The battery cell 100 can include at least one housing 105. The housing 105 can have a first end 110 and a second end 115. The battery cell 100 can be a lithium-air battery cell, a lithium ion battery cell, a nickel-zinc battery cell, a zinc-bromine battery cell, a zinc-cerium battery cell, a sodium-sulfur battery cell, a molten salt battery cell, a nickel-cadmium battery cell, or a nickel-metal hydride battery cell, among others. The housing 105 can be included or contained in a battery pack (e.g., a battery array or battery module) installed a chassis of an electric vehicle. The housing 105 can have the shape of a cylindrical casing or cylindrical cell with a circular, ovular, or elliptical base, as depicted in the example of the battery cell of FIG. 1. A height of the housing 105 can be greater than a width of the housing 105. For example, the housing 105 can have a length (or height) in a range from 65 mm to 75 mm and a width (or diameter for circular examples) in a range from 15 mm to 27 mm. In some examples the width or diameter of the housing 105 can be greater than the length (e.g., height) of the housing 105. The housing 105 can be formed from a prismatic casing with a polygonal base, such as a triangle, square, a rectangular, a pentagon, or a hexagon, for example. A height of such a prismatic cell housing 105 can be less than a length or a width of the base of the housing 105. The battery cell 100 can be a cylindrical cell 21 mm in diameter and 70 mm in height. Other shapes and sizes are possible, such as a rectangular cells or rectangular cells with rounded edges, of cells between 15 mm to 27 mm in diameter or width, and 65 mm to 75 mm in length or height.

The housing 105 of the battery cell 100 can include at least one electrically or thermally conductive material, or combinations thereof. The electrically conductive material can also be a thermally conductive material. The electrically conductive material for the housing 105 of the battery cell 100 can include a metallic material, such as aluminum, an aluminum alloy with copper, silicon, tin, magnesium, manganese or zinc (e.g., of the aluminum 4000 or 5000 series), iron, an iron-carbon alloy (e.g., steel), silver, nickel, copper, and a copper alloy, among others. The electrically conductive material and thermally conductive material for the housing 105 of the battery cell 100 can include a conductive polymer. To evacuate heat from inside the battery cell 100, the housing 105 can be thermally coupled to a thermoelectric heat pump (e.g., a cooling plate) via an electrically insulating layer. The housing 105 can include an electrically insulating material. The electrically insulating material can be a thermally conductive material. The electrically insulating and thermally conductive material for the housing 105 of the battery cell 100 can include a ceramic material (e.g., silicon nitride, silicon carbide, titanium carbide, zirconium dioxide, beryllium oxide, and among others) and a thermoplastic material (e.g., polyethylene, polypropylene, polystyrene, or polyvinyl chloride), among others. To evacuate heat from inside the battery cell 100, the housing 105 can be thermally coupled to a thermoelectric heat pump (e.g., a cooling plate). The housing 105 can be directly thermally coupled to the thermoelectric heat pump without an addition of an intermediary electrically insulating layer.

The housing 105 of the battery cell 100 can include the first end 110 (e.g., top portion) and the second end 115 (e.g., bottom portion). The housing 105 can define an inner region 120 between the first end 110 and the second end 115. For example, the inner region 120 can include an interior of the housing 105 or an inner area formed by the housing 105. The first end 110, inner region 120, and the second end 115 can be defined along one axis of the housing 105. For example, the inner region 120 can have a width (or diameter for circular examples) of 2 mm to 6 mm and a length (or height) of 50 mm to 70 mm. The width or length of the inner region 120 can vary within or outside these ranges. The first end 110, inner region 120, and second end 115 can be defined along a vertical (or longitudinal) axis of cylindrical casing forming the housing 105. The first end 110 at one end of the housing 105 (e.g., a top portion as depicted in FIG. 1). The second end 115 can be at an opposite end of the housing 105 (e.g., a bottom portion as depicted in FIG. 1). The end of the second end 115 can encapsulate or cover the corresponding end of the housing 105.

The first end 110 can include or be formed having an indentation or indentation shape. For example, the first end 110 can include or be defined by a bend or indentation 125. The indentation 125 can include a groove, slit, slot, recess or notch formed into an outer surface of the first end 110. The indentation 125 can provide a surface to couple a base portion 140 of a lid 135 with the housing 105. The indentation 125 of the first end 110 can be formed by crimping, squeezing, or applying any pressure on an outer surface of the first end of the housing 105 along one axis. The indentation 125 can have a width less than a width of the housing 105 or first end 110. For example, the diameter (or width) of the indentation 125 can be in a range from 15 mm to 20 mm. The diameter (or width) of the first end 110 (not including the indentation) can be in a range from 15 mm to 27 mm. The diameter (or width) can correspond to a shortest dimension along an inner surface of the housing 105 within the indentation 125, first end 110, or second end 115. The width can correspond to a width of a rectangular or polygonal lateral area of the indentation 125, first end 110, or second end 115. The diameter (or width) can correspond to a diameter of a circular or elliptical lateral area of the indentation 125, first end 110, or second 115. The lateral area of the indentation 125 can also be less than a lateral area of the first end 110 (not including the indentation) and a lateral area of the second end 115 of the housing 105. The width of the first end 110 (not including the indentation) can be less than the width of the second end 115 of the housing 105 but greater than the width of the indentation 125. The lateral area of the first end 110 (not including the indentation) can be less than the lateral area of the second end 115 of the housing 105 but greater than the lateral area of the indentation 125.

At least one electrolyte 130 can be disposed in the inner region 120 of the housing 105. The battery cell 100 can include multiple electrolytes 130 disposed in the inner region 120 of the housing. The electrolyte 130 can include a first polarity electronic charge region or terminus and a second polarity electronic charge region or terminus. For example, the electrolyte 130 can include a positive electronic charge region or terminus and a negative electronic charge region or terminus. A first polarity tab (e.g., positive tab) can couple a first polarity region of the electrolyte with a first polarity layer or first polarity region of the lid 135 to form a first polarity surface area (e.g., positive surface area) on the lid 135 for first polarity wire bonding. For example, the base portion 140 or the extended portion 145 can correspond to a first polarity layer or first polarity region of the lid 135. At least one second polarity tab (e.g., negative tab) can couple a second polarity region of the electrolyte 130 (e.g., negative region of electrolyte 130) with the surface of the housing 105 or a second polarity layer or second polarity region of a lid 135. For example, a second polarity region of the electrolyte 130 can couple with one or more surfaces of the housing 105 or a second polarity layer or second polarity region of the lid 135, such as to form a second polarity surface area (e.g., negative surface area) on the lid 135 for second polarity wire bonding. For example, the base portion 140 or the extended portion 145 can correspond to a second polarity layer or second polarity region of the lid 135. The electrolyte 130 can include any electrically conductive solution, dissociating into ions (e.g., cations and anions). For a lithium-ion battery cell, for example, the electrolyte 130 can include a liquid electrolyte, such as lithium bisoxalatoborate (LiBC4O8 or LiBOB salt), lithium perchlorate (LiClO4), lithium hexaflourophosphate (LiPF6), and lithium trifluoromethanesulfonate (LiCF3SO3). The electrolyte 130 can include a polymer electrolyte, such as polyethylene oxide (PEO), polyacrylonitrile (PAN), poly (methyl methacrylate) (PMMA) (also referred to as acrylic glass), or polyvinylidene fluoride (PVdF). The electrolyte 130 can include a solid-state electrolyte, such as lithium sulfide (Li2S), magnesium, sodium, and ceramic materials (e.g., beta-alumna). A single electrolyte 130 can be disposed within inner region 120 of the housing 105 or multiple electrolytes 130 (e.g., two electrolytes, more than two electrolytes) can be disposed within inner region 120 of the housing 105. For example, two electrolytes 130 can be disposed within inner region 120 of the housing 105. The number of electrolytes 130 can vary and can be selected based at least in part on a particular application of the battery cell 100.

At least one lid 135 can be disposed proximate to the first end 110 of the housing 105. The lid 135 can be disposed onto the first lateral end 110 of the housing 105. The lid 135 can include a base portion 140 and an extended portion 145. The base portion 140 can couple the lid 135 with the first end 110 of the housing 105. The seal formed between the base portion 140 and the first end 110 of the housing 105 can be a hermetic seal or fluid resistant seal, for example, so that the electrolyte 130 does not leak from its location within the housing 105. The base portion 140 can couple with the indentation 125 of the first end 110 of the housing 105 to couple the lid 135 with the first end 110 of the housing 105. The base portion 140 can be crimped onto, clipped onto, or welded with the indentation 125 to couple the lid 135 with the first end 110 of the housing 105. The coupling (e.g., crimped coupling, welded coupling) between the base portion 140 and the first end 110 of the housing 105 can form a hermetic seal, a fluid resistant seal, or a hermetic seal and a fluid resistant seal between the lid 135 and the housing 105.

The base portion 140 can couple with the first end 110 of the housing 105 through a connector 170. The connector 170 can house, retain, hold, secure, seal, or otherwise include the base portion 140 with the first end 110 of the housing 105. The connector 170 can couple with edge surfaces of each of the base portion 140 and the first end 110 of the housing 105. The connector 170 can couple with portions of each of the base portion 140 and the first end 110 to couple the base portion 140 with the first end 110. For example, the connector 170 can include a first portion that can be disposed over and couple with a portion of the base portion 140. The connector 170 can include a second portion that can be disposed over and couple with a portion of the first end 110 to couple the base portion 140 with the first end 110. The connector 170 can include a threaded inner surface. A region of the outer surface of the base portion 140 can include a threaded surface and a region of the outer surface of the first end 110 can include a threaded surface. The threaded inner surface of the connector 170 can couple with the threaded outer surface of the base portion 140 and the threaded outer surface of the first end 110 to couple the base portion 140 with the first end 110. The connector 170 can include a gasket, O-ring, brass fitting, or other forms of fasteners to couple the base portion 140 with the first end 110 of the housing 105. The connector 170 can be formed from a variety of different materials, including but not limited to, include rubber material, steel material (e.g., stainless steel), metal material, or metallic material. The seal formed by the connector 170 can include any type of mechanical seal, such as a hermetic seal, an induction seal, a hydrostatic seal, a hydrodynamic seal, and a bonded seal, among others.

The base portion 140 can be formed having a shape corresponding to the shape of the housing 105. For example, the base portion 140 can be formed having a circular, ovular, elliptical, rectangular, or square shape. The base portion 140 can be formed from the same material as the housing 105. The base portion 140 can be formed from a different material from the material forming the housing 105. For example, the base portion 140 can include, but not limited to, a metallic material, aluminum, an aluminum alloy with copper, silicon, tin, magnesium, manganese or zinc (e.g., of the aluminum 4000 or 5000 series), iron, an iron-carbon alloy (e.g., steel), silver, nickel, copper, and a copper alloy, among others. The base portion 140 can have a diameter in a range from 15 mm to 27 mm. The diameter of the base portion 140 can vary within or outside this range. The base portion 140 can have a height (e.g. vertical width, vertical length) in a range from 0.5 mm to 2 mm (e.g., 1 mm). The height of the base portion 140 can vary within or outside this range. The base portion 140 can have a thickness (e.g., distance from an inner surface to an outer surface of the base portion 140) in a range from 0.1 mm to 1 mm (e.g., 0.35 mm). The thickness of the base portion 140 can vary within or outside this range.

The extended portion 145 can be an extension of the base portion 140. For example, the extended portion 145 can be integrally formed with the base portion 140 such that the base portion 140 and the extended portion 145 are a single continuous element. The extended portion 145 can be coupled with the base portion 140. For example, the extended portion 145 can be welded with the base portion 140 to form the lid 135. The extended portion 145 can be formed having a shape corresponding to the shape of the base portion 140. The extended portion 145 can be formed having a shape corresponding to the shape of the housing 105. For example, the extended portion 145 can be formed having a circular, ovular, elliptical, rectangular, or square shape. The extended portion 145 can be formed from the same material as the base portion 140. The extended portion 145 can be formed from the same material as the housing 105. The extended portion 145 can be formed from a different material from the material forming the housing 105. For example, the extended portion 145 can include, but not limited to, a metallic material, aluminum, an aluminum alloy with copper, silicon, tin, magnesium, manganese or zinc (e.g., of the aluminum 4000 or 5000 series), iron, an iron-carbon alloy (e.g., steel), silver, nickel, copper, and a copper alloy, among others. The extended portion 145 can have a height (e.g., length, vertical length) in a range from 3 mm to 20 mm. The height of the extended portion 145 can vary within or outside this range. The extended portion 145 can have a diameter in a range from 0.5 mm to 18 mm. The diameter of the extended portion 145 can vary within or outside this range. The extended portion 145 can have a thickness (e.g., distance from an inner surface to an outer surface of the extended portion 145) in a range from 0.1 mm to 1 mm (e.g., 0.35 mm). The thickness of the extended portion 145 can vary within or outside this range. The lid 135 can be formed such that the extended portion 145 has a different height with respect to a first surface (e.g., top surface) of the first end 110 of the housing 105 as compared to a height of the base portion 140. For example, the extended portion 145 can have a first height with respect to the first surface of the first end 110 of the housing 105 and the base portion 140 can have a second height with respect to the first surface of the first end 110 of the housing 105. The first height can be greater than the second height. For example, the extended portion 145 can be formed having a greater height than the base portion 140. The lid 135 can be formed such that the extended portion 145 has a different diameter than the base portion 140. For example, the extended portion 145 can have a first diameter and the base portion 140 can have a second diameter. The first diameter can be less than the second diameter. For example, the extended portion 145 can be formed within the diameter of the base portion 140 and form a middle region of the base portion 140.

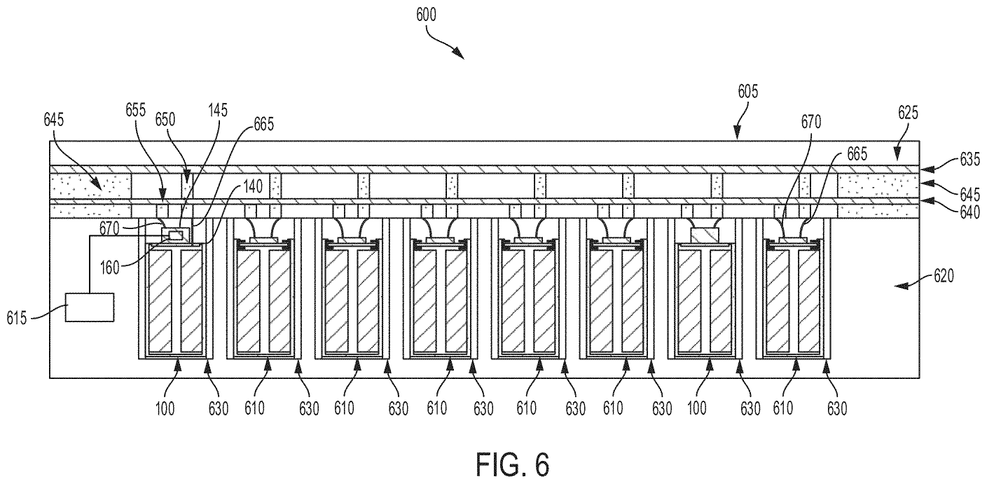

The lid 135 can include a first polarity layer (e.g., positive polarity), a second polarity layer (e.g., negative polarity), or both a first polarity and a second polarity. For example, the base portion 140 can be a first polarity layer (e.g., positive polarity) or a second polarity layer (e.g., negative polarity). The extended portion 145 can be a first polarity layer (e.g., positive polarity) or a second polarity layer (e.g., negative polarity). The base portion 140 can have a different polarity from the extended portion 145. The base portion 140 can have the same polarity as the extended portion 145. The base portion 140 and extended portion 145 can have the same polarity as the housing 105. The base portion 140 or extended portion 145 can have a different polarity from the housing 105. The housing 105 can be formed from non-conductive material and the base portion 140 can have a first polarity and the extended portion 145 can have a second polarity. The second polarity can be different from the first polarity. The base portion 140 or the extended portion 145 can operate as a first polarity terminal (e.g., positive terminal) of the battery cell 100. The base portion 140 or the extended portion 145 can operate as a second polarity terminal (e.g., negative terminal) of the battery cell 100. For example, the battery cell 100 can couple with a first polarity busbar and a second polarity busbar (e.g., positive and negative busbars, positive and negative current collectors) of a battery pack of an electric vehicle through the base portion 140 or the extended portion 145 of the lid 135 (as shown in FIG. 6). Via a module tab connection (or other techniques such as wire bonding of a wire), the base portion 140 or the extended portion 145 can couple the battery cell 100 with busbars of the battery pack from the same end or common end (e.g., top or bottom) or from longitudinal sides of the battery cell 100. The battery pack can be disposed in an electric vehicle to power a drive train of the electric vehicle.

The base portion 140 or the extended portion 145 can couple with one or more electrolytes 130 disposed within the inner region 120 of the housing 105. For example, the base portion 140 or the extended portion 145 can couple with at least one electrolyte 130 through one or more tabs. A first polarity tab can couple the electrolyte 130 (e.g., positive region of the electrolyte 130) with the base portion 140 or the extended portion 145. The first polarity tab can extend from a first polarity region of the electrolyte 130 to at least one surface of the base portion 140 or the extended portion 145. A second polarity tab can couple the electrolyte 130 with the base portion 140 or the extended portion 145. The second polarity tab can extend from a second polarity region of the electrolyte 130 to at least one surface (e.g., bottom surface) of the base portion 140 or the extended portion 145. The second polarity tab can electrically couple the base portion 140 or the extended portion 145 with the second polarity region of the electrolyte 130. When the base portion 140 or the extended portion 145 is coupled with the electrolyte 130 through the second polarity tab, the housing 105 may include non-conductive material. The lid 135 can include at least one insulation material 165. The at least one insulation material 165 can separate or electrically isolate the base portion 140 and the extended portion 145 when the base portion 140 and the extended portion 145 have different polarities. The insulation material 165 may include dielectric material. For example, the insulation material 165 can include at least one surface coupled with at least one surface of the base portion 140 and a second surface coupled with the extended portion 145 such that the insulation material 165 is disposed between the base portion 140 and the extended portion 145. Thus, the insulation material 165 may include an adhesive layer to couple the base portion 140 with the extended portion 145.

The extended portion 145 can include an inner cavity 150. The inner cavity 150 can correspond to an inner region, inner area, or interior of the extended portion 145. For example, the inner cavity 150 can include one or more inner surfaces of the extended portion 145. The inner cavity 150 can have dimensions based in part on the dimensions of the extended portion 145. For example, the inner cavity 150 can have a height (e.g., length, vertical length) in a range from 3 mm to 20 mm. The height of the inner cavity 150 can vary within or outside this range. The inner cavity 150 can have a diameter in a range from 0.5 mm to 17 mm. The diameter of the inner cavity 150 can vary within or outside this range. A wall of the inner cavity 150 can have a thickness (e.g., distance from an inner surface to an outer surface of the inner cavity 150) in a range from 0.1 mm to 1 mm (e.g., 0.35 mm). The thickness of the wall of the inner cavity 150 can vary within or outside this range.

The extended portion 145 can include a threaded hole 155. The threaded hole 155 can form an opening, a port or be part of an opening of the inner cavity 150. For example, the threaded hole 155 can be formed within the inner cavity 150 of the extended portion 145. The threaded hole 155 can form a connection point within the inner cavity 150, for example, to couple a sensor element 160 with the extended portion 145. The threaded hole 155 can include a pattern formed into a portion of the inner surface of the inner cavity 150. For example, the threaded hole 155 can include a series of ridges, a screw thread pattern, or deformations formed into a portion of the inner surface of the inner cavity 150 to receive a threaded surface of another component, such as but not limited to, a sensor element 160 or sensor wire. The threaded hole 155 can be formed at a bottom region or bottom portion of the inner cavity 150. The threaded hole 155 can be formed at a middle region or middle portion (e.g., as shown in FIG. 1) of the inner cavity 150. The threaded hole 155 can be formed at a top region or top portion of the inner cavity 150. The inner cavity 150 may include a threaded hole 155 or threaded inner surface formed an entire length (e.g., top to bottom) of an inner surface of the inner cavity 150. The threaded hole 155 can have a circular, ovular, elliptical, rectangular, or square shape. The shape of the threaded hole 155 can correspond to the shape of the inner cavity 150. The lid 135 can include multiple threaded holes 155. For example, a first threaded hole 155 can couple with or formed within the inner cavity 150 and a second threaded hole 155 can couple with or be formed within the inner cavity 150. The first threaded hole 155 can receive and couple with a first sensor element 160. The second threaded hole 155 can receive and couple with a second sensor element 160. The first sensor element 160 can be a different type of sensor from the second sensor element 160. For example, the first sensor element 160 can collect different measurements corresponding to the battery cell 100 from the second sensor element 160. The first sensor element 160 can be the same type of sensor as the second sensor element 160 and disposed within a different portion of the inner cavity 150 to obtain measurements from a different portion of the inner cavity 150 or housing 105 as compared to the second sensor element 160.

A sensor element 160 can couple with the threaded hole 155 of the extended portion 145. For example, the sensor element 160 can include a threaded outer surface that can couple with the threaded hole 155 to secure the sensor element within the inner cavity 150. The threaded outer surface of the sensor element 160 can screw into the threaded hole 155 to couple the sensor element 160 within the inner cavity 150 of the extended portion 145. A connector can be used to couple the sensor element 160 with the threaded hole 155. For example, a connector (e.g., brass fitting, fastener) can couple with at least one surface of the sensor element 160 and couple with at least one surface of the threaded hole 155 to couple the sensor element 160 with the threaded hole 155.

The sensor element 160 can include a sensor, a sensor wire, or a sensor coupled with a sensor wire. For example, the sensor element 160 can include at least one sensor coupled with the threaded hole 155 of the extended portion 145 and disposed within the inner cavity 150. The sensor element 160 can include at least one sensor wire coupled with the threaded hole 155 of the extended portion 145 and disposed within the inner cavity 150. The sensor element 160 can include at least one sensor wire coupled with the threaded hole 155 of the extended portion 145, the sensor wire coupled with at least one sensor, and the sensor wire and sensor can be disposed within the inner cavity 150. The sensor element 160 can include a transducer, a thermocouple, a composition sensor, or a flow meter. For example, the sensor element 160 can include at least one sensor coupled with the threaded hole 155 of the extended portion 145. The sensor element 160 can be disposed within the inner cavity 150 such that the sensor element 160 is spaced a distance from at least one surface (e.g., top surface) of the electrolyte 130 within the inner region 120 of the housing 105. For example, the sensor element 160 can be spaced a distance in a range from 0.1 mm to 40 mm from at least one surface of the electrolyte 130. The distance the sensor element 160 is spaced from at least one surface of the electrolyte 130 can vary within or outside this range. The inner cavity 150 can be hollow or have an open inner area such that at least one surface (e.g., bottom surface) of the sensor element 160 is exposed to the inner region 120 disposed within the housing 105. The sensor element 160 can be positioned such that at least one surface of the sensor element 160 is exposed to sense or detect properties of an environment within the battery cell 100 or components (e.g., electrolyte 130) within the housing 105 of the battery cell 100. For example, the sensor element 160 can sense or collect sensor data, such as but not limited to, pressure data corresponding to a pressure value within the battery cell 100. The sensor element 160 can sense or collect sensor data, such as but not limited to, temperature data corresponding to a temperature value within the battery cell 100. The sensor element 160 can sense or collect sensor data, such as but not limited to, composition data corresponding to a composition of components such as an electrolyte 130 within the battery cell 100. The sensor element 160 can sense or collect sensor data, such as but not limited to, flow data corresponding to a flow value within the battery cell 100. The sensor element 160 can sense or collect sensor data, such as but not limited to, gas chromatography-mass spectroscopy (GCMS) measurements of a chemical composition of the gases produced during cell formation within the battery cell 100.

An insulation material 165 can be disposed between the electrolyte 130 and one or more portions of the lid 135 or the sensor element 160. For example, an insulation material 165 can be disposed between at least one surface (e.g., top surface) of the electrolyte 130 and the sensor element 160. The insulation material 165 can separate or electrically isolate the electrolyte 130 from one or more portions of the lid 135 or the sensor element 160. An insulation material 165 may be disposed between an inner surface of the housing 105 and the electrolyte 130 disposed within the inner region 120 of the housing 105 to electrically insulate the housing 105 from the electrolyte 130. The insulation material 165 may include dielectric material. For example, the insulation material 165 can include, but not limited to, polymer material, insulation material, plastic material, epoxy material, FR-4 material, polypropylene materials, or formex materials.

The battery cells 100 described herein can include both the positive terminal and the negative terminal disposed at a same lateral end (e.g., the top end) of the battery cell 100. For example, the lid 135 can provide a first polarity terminal (e.g., positive terminal) for the battery cell 100 at the first end 110 and a second polarity terminal (e.g., negative terminal) for the battery cell 100 at the first end 110. Having both terminals, for the positive and the negative terminals on one end of the battery cell 100 can eliminate wire bonding to one side of the battery pack and welding of a tab to another side of the battery cell 100 (e.g., the bottom end or the crimped region). In this manner, a terminal or an electrode tab along the bottom of the battery cell 100 can be eliminated from the structure. Thus improving the pack assembly process by making it easier to bond the wire to each of the first polarity terminal (e.g., positive terminal) and the second polarity terminal (e.g., negative terminal) of the battery cell 100. For example, the battery cell 100 can be attached to a first polarity busbar by bonding at least one wire between the at least one surface of the lid 135 and the first polarity busbar. The battery cell 100 can be attached to a second polarity busbar by bonding at least one wire between at least one surface of the lid 135 and the second polarity busbar. Each battery cell 100 can be attached to the second polarity busbar by bonding at least one wire to a side surface of the first end 110 or second end 115 (e.g., bottom surface) of the housing 105 of the battery cell 100.

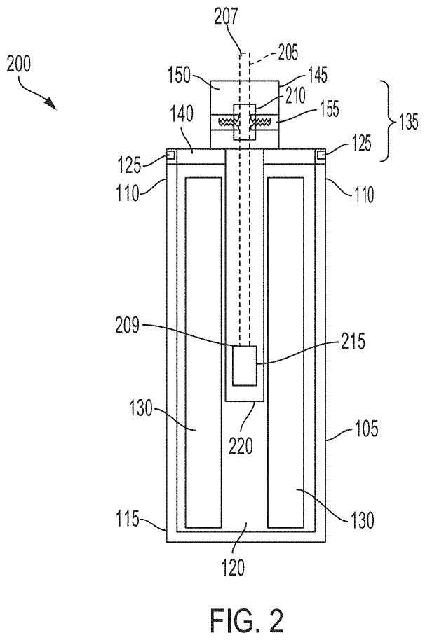

FIG. 2, among others, depicts a view 200 of a battery cell 100 having a lid 135 and a housing 105. The lid 135 includes an extended portion 145 having an inner cavity 150 and a threaded hole. At least one sensor wire 205 can couple with the threaded hole and couple with at least one sensor 215 disposed within the housing 105. For example, the sensor wire 205 can include a first portion coupled with the threaded hole 155 of the inner cavity 150 and at least one end coupled with the sensor 215. The sensor wire 205 can include a threaded outer surface portion that couples with the threaded hole 155 of the inner cavity 150. The seal formed between the sensor wire 205 and the threaded hole 155 can include any type of mechanical seal, such as a hermetic seal, an induction seal, a hydrostatic seal, a hydrodynamic seal, and a bonded seal, among others. For example, the sensor wire 205 can couple with the threaded hole 155 such that the seal of the battery cell 100 is maintained. Thus, the threaded hole 155 can provide a pathway for the sensor wire 205 to couple the sensor 215 with a battery monitoring unit or other form of an external sensor and obtain readings from corresponding to the battery cell 100. The sensor wire 205 can include multiple sensor wires 205. The multiple sensor wires 205 can couple with the threaded hole 155. For example, the threaded hole 155 can include multiple threaded holes 155. Each of the multiple threaded holes 155 can couple with at least one sensor wire 205. The sensor wire 205 can include conductive material. The sensor wire 205 can provide or form a signal path from the sensor 215 to a battery monitoring unit or other form of an external sensor to transmit control signals, receive control signals, obtain readings, or provide other forms of signal feedback. The sensor wire 205 can include conductive material covered by an outer jacket of non-conductive material (e.g., dielectric material). The sensor wire 205 can include multiple sensor wires 205 disposed within a single outer jacket of non-conductive material. The sensor wire 205 can have a length in a range from 5 mm to 60 mm in length or height. The length of the sensor wire 205 can vary within or outside this range.

A connector 210 can be disposed between the sensor wire 205 and the threaded hole 155 of the extended portion 145 to couple the sensor wire 205 with the threaded hole 155. For example, the connector 210 can couple with or be disposed around an outer surface of the sensor wire 205. The connector 210 can include a threaded outer surface that couples with the threaded hole 155 of the inner cavity 150 to secure the sensor wire 205 to the inner cavity 150. For example, the connector 210 can be disposed between the threaded hole 155 of the extended portion 145 and the sensor element 160. At least one first surface of the connector 210 can couple with the threaded hole 155 of the extended portion 145. At least one second surface of the connector 210 can couple with the sensor element 160 to couple the sensor element 160 with the threaded hole 155 of the extended portion 145 of the lid 135. The connector 210 can couple with the extended portion 145 such that the connector 210 is disposed between the threaded hole 155 of the extended portion 145 and the sensor element 160. A sealing agent can be disposed between the connector 210 and the threaded hole 155 of the extended portion 145. The sealing agent forms a hermetic seal and a fluid resistant seal between the connector 210 and the threaded hole 155 of the extended portion 145. The sealing agent may include, but not limited to, an adhesive material or epoxy material. The connector 210 can include a gasket, O-ring, brass fitting, or other forms of fasteners to couple at least one sensor element 160 with the threaded hole 155. The connector 210 can be formed from a variety of different materials, including but not limited to, include rubber material, steel material (e.g., stainless steel), metal material, or metallic material. The seal formed by the connector 210, between the sensor element 160 (e.g., sensor wire 205, sensor 215) and the threaded hole 155, can include any type of mechanical seal, such as a hermetic seal, an induction seal, a hydrostatic seal, a hydrodynamic seal, and a bonded seal, among others.

The sensor wire 205 can include a first end 207 that extends out of the extended portion 145. For example, the first end 207 can extends out of the extended portion 145 to couple with a battery monitoring unit (e.g., battery monitoring unit 615 of FIG. 6) or other form of an external sensor to provide readings or measurements corresponding to the battery cell 100. The sensor wire 205 can include a second end 209 that couples with the sensor 215 within a column region 220 of the inner region 120 of the housing 105. The sensor 215 can include, but not limited to, a transducer, a thermocouple, a composition sensor, a flow meter, or devices for gas chromatography-mass spectrometry. The battery cell 100 can include a single sensor 215. The battery cell 100 can include multiple sensors 215. For example, the battery cell 100 can include different types of sensors 215 to measure different properties of the battery cell 100 or components within the battery cell 100. The battery cell 100 can include a first sensor 215 to measure a first property of the battery cell 100 or components within the battery cell 100. The battery cell 100 can include a second sensor 215 to measure a second property of the battery cell 100 or components within the battery cell 100. The second sensor 215 can be different from the first sensor and the second property can be a different property of the battery cell 100 or components within the battery cell 100 as compared to the first property. The sensor 215 can be disposed proximate to or adjacent to, or next to at least one portion of the electrolyte 130. For example, the sensor 215 can be disposed proximate to or adjacent to, or next to a top portion or top region of the electrolyte 130. The sensor 215 can be disposed proximate to or adjacent to, or next to a middle portion or middle region of the electrolyte 130. The sensor 215 can be disposed proximate to or adjacent to, or next to a bottom portion or bottom region of the electrolyte 130.

The column region 220 can include a separate compartment formed within the inner region 120. For example, the column region 220 can be formed from dielectric material or non-conductive material to electrically isolate the sensor 215 from an electrolyte 130 disposed with the inner region 120. The column region 220 can be disposed in a top portion or top region of the inner region 120. The column region 220 can be disposed in a middle portion or middle region of the inner region 120. The column region 220 can be disposed in a bottom portion or bottom region of the inner region 120. The sensor 215 can be disposed in a top portion or top region of the column region 220. The sensor 215 can be disposed in a middle portion or middle region of the column region 220. The sensor 215 can be disposed in a bottom portion or bottom region of the column region 220. Multiple sensors 215 can be disposed within the column region 220. For example, a first sensor 215 can be disposed at a first portion (e.g., top region, middle region, bottom region) of the column region 220 and a second sensor 215 can be disposed at a second portion of the column region 220. The second portion of the column region 220 can be different from the first portion of the column region 220. Thus, the first sensor 215 and the second sensor 215 can be disposed at in different portions of the column region 220.

The first sensor 215 and the second sensor 215 can be disposed adjacent to or proximate to different portions of the electrolyte 130 within the column region 220. For example, a first sensor 215 can be disposed proximate to or adjacent to a first portion (e.g., top region, middle region, bottom region) of the electrolyte 130 and a second sensor 215 can be disposed at a second portion of the electrolyte 130. The second portion of the electrolyte 130 can be different from the first portion of the electrolyte 130. An insulation material 165 can be disposed between the electrolyte 130 and the column region 220 to separate or electrically isolate the electrolyte 130 from column region 220. The column region 220 may include insulation material 165 to electrically isolate the electrolyte 130 from one or more sensor wires 205 disposed within the column region 220 or one or more sensors 215 disposed within the column region 220. The column region 220 can have a height (e.g., length, vertical length) in a range from 3 mm to 60 mm. The height of the column region 220 can vary within or outside this range. The column region 220 can have a diameter in a range from 0.5 mm to 17 mm. The diameter of the column region 220 can vary within or outside this range. The column region 220 can be formed having a circular, ovular, elliptical, rectangular, or square shape. The column region 220 can correspond to or be used for gas chromatography-mass spectroscopy (GCMS) devices or measurements. For example, the sensor 215 can be disposed within the column region 220 to measure the chemical composition of the gases produced during cell formation. The sensor 215 can measure internal variables of the battery cell 100 during the cell formation process wherein the solid electrolyte interphase (SEI) is first formed. The sensor 215 can measure internal variables of the battery cell 100 and the electrolyte 130 when the respective battery cell 100 is disposed within a battery pack and during operation of an electronic vehicle.

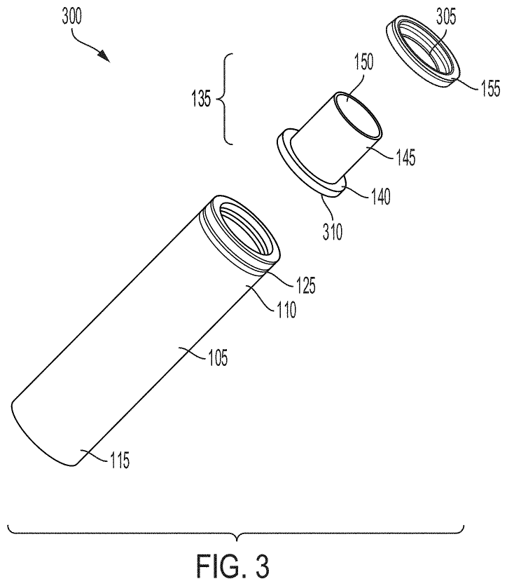

FIG. 3, among others, depicts a view 300 of a lid 135 separated from a housing of a battery cell 100 to illustrate the different components of the lid 135. For example, the lid can include a base portion 140 and an extended portion 145. A threaded hole 155 is separated from an inner cavity 150 of the extended portion 145. The threaded hole 155 can include a threaded inner surface 305. The threaded inner surface 305 can be formed to receive a threaded surface of a sensor element 160 (e.g., sensor wire 205, sensor 215) or a connector 210. The threaded inner surface 305 can include a series of raised surfaces or a pattern of raised surfaces (e.g., corkscrew pattern). The threaded inner surface 305 can include a continuous raised surface that wraps around or extends around the inner surface of the threaded hole 155. The threaded inner surface 305 can include a ridge or uniform section in the form of a helix on the internal surface of threaded hole 155, or in the form of a conical spiral on the internal surface of the threaded hole 155. The threaded inner surface 305 can include a series of notches or connection points to couple with indentations or connection points formed on an outer surface of a sensor element 160 (e.g., sensor wire 205, sensor 215). The threaded hole 155 can form a port or orifice to provide a feedthrough for different sensor elements. For example, one or more sensor elements can couple with or plug into the battery cell 100 through the threaded hole 155 to obtain measurements or readings from the battery cell 100. Thus, the sensor data can be obtained from the battery cell 100 in a non-invasive manner and without damaging the integrity of the respective battery cell 100. The threaded hole 155 can be formed into an inner surface of the inner cavity 150. The threaded hole 155 can be a separate component from the inner cavity 150 of the extended portion 145. For example, the threaded hole 155 can be disposed within the inner cavity 150. The threaded hole 155 can couple with or welded to an inner surface of the inner cavity 150.

The base portion 140 can include at least one crimped edge 310. The crimped edge 310 can couple the lid 135 with the first end 110 of the housing 105. For example, the base portion 140 can include one or more crimped edges 310 to house, retain, hold, secure, or seal the lid 135 to the first end 110 of the housing 105. The crimped edge 310 can include an edge portion or end portion of the base portion 140 that has been crimped, bent, or otherwise manipulated to form over at least one surface (e.g., top surface) of the first end 110 of the housing 105. The crimped edge 310 can be formed such that the respective crimped edge bends over (or are crimped over) the surface of the first end 110 to secure the lid 135 to the housing 105 and seal the battery cell 100. The seal formed by the crimped edge 310, between the lid 135 and the first end 110 of the housing 105, can include any type of mechanical seal, such as a hermetic seal, an induction seal, a hydrostatic seal, a hydrodynamic seal, and a bonded seal, among others.

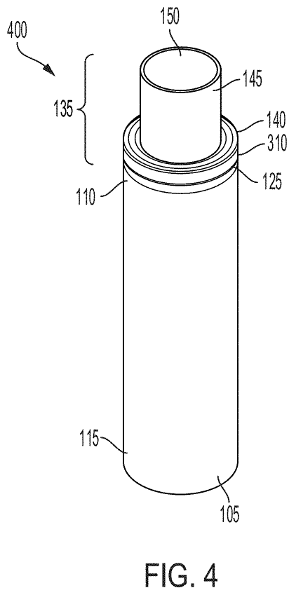

FIG. 4, among others, depicts a view 400 of a lid 135 coupled with a first end 110 of a housing 105. In particular, view 400 depicts a crimped edge 310 of a base portion 140 of the lid 135 coupled with an indentation 125 of the first end 110 of the housing 105. The crimped edge 310 can be formed such that a portion of the crimped edge 310 couples with the indentation 125 of the first end 110. For example, an edge portion or end portion of the base portion 140 that has been crimped, bent, or otherwise manipulated such that a portion of the crimped edge 310 can be crimped into the indentation 125 of the first end 110 to couple the lid 135 with the housing 105. The crimped edge 310 can fold, pinch, be bent towards or engage with the indentation 125 of the first end 110 to seal the battery cell 100. The crimped edge 310 can be crimped onto, clipped onto, or welded with the indentation 125 to couple the lid 135 with the first end 110 of the housing 105. The crimped edge 310 can have a length from its respective outer diameter to its respective inner diameters in a range of 1 mm to 3 mm (the length can vary within or outside this range) and can span or cover portions of the first end 110 in a range of 360 degrees. The thickness or length from the outer diameter to the inner diameter of the crimped edge 310 can be formed to be similar or the same as the thickness of the housing 105 (e.g., 0.15 mm to 0.35 mm).

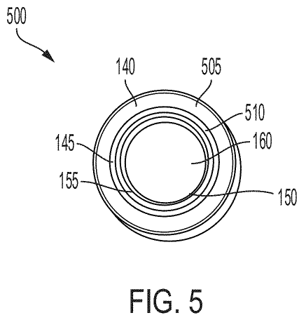

FIG. 5, among others, depicts a top view 500 of a lid 135 coupled with a first end 110 of a housing 105. The lid 135 includes a base portion 140 and an extended portion 145. The base portion 140 includes a first surface 505 (e.g., top surface) and the extended portion 145 can include a first surface 510 (e.g., top surface). The first surface 505 of the base portion 140 can have a width in a range from in a range from 0.1 mm to 2 mm (e.g., 0.5 mm). The width of the first surface 505 can correspond to a distance or length from an outer edge (or outer surface) of the base portion 140 to an inner edge (or inner surface) of the base portion 140 that contacts the extended portion 145. The width of the first surface 505 of the base portion 140 can vary within or outside this range. The first surface 510 of the extended portion 145 can have a width in a range from in a range from 0.1 mm to 2 mm (e.g., 0.5 mm). The width of the first surface 510 can correspond to a distance or length from an outer edge (or outer surface) of the extended portion 145 that contacts the base portion 140 to an inner edge (or inner surface) of the extended portion 145. The width of the first surface 510 of the extended portion 145 can vary within or outside this range. The first surface 505 of the base portion 140 can be a first polarity layer (e.g., positive polarity) or a second polarity layer (e.g., negative polarity). For example, a first polarity wirebond or a second polarity wirebond can include a first end coupled with the first surface 505 and a second end coupled with a first polarity busbar or a second polarity bus bar of a battery pack of an electric vehicle. The first surface 510 of the extended portion 145 can be a first polarity layer (e.g., positive polarity) or a second polarity layer (e.g., negative polarity). The first surface 505 of the base portion 140 can have a different polarity from the first surface 510 of the extended portion 145. For example, a first polarity wirebond or a second polarity wirebond can include a first end coupled with the first surface 510 and a second end coupled with a first polarity busbar or a second polarity bus bar of a battery pack of an electric vehicle. The first surface 505 of the base portion 140 can have the same polarity as the first surface 510 of the extended portion 145. The first surface 505 of the base portion 140 and first surface 510 of the extended portion 145 can have the same polarity as the housing 105. The first surface 505 of the base portion 140 or the first surface 510 of the extended portion 145 can have a different polarity from the housing 105.

As depicted in FIG. 5, a sensor element 160 is disposed within the inner cavity 150 of the extended portion 145. The sensor element 160 can couple with the threaded hole 155 of the inner cavity 150 to secure the sensor element 160 within the extended portion 145. The sensor element 160 can be disposed within the extended portion 145 such that the sensor element 160 is spaced from an electrolyte 130 disposed within a housing 105 of a battery cell 100 (e.g., as shown in FIGS. 1-2). The threaded hole 155 can be positioned within the inner cavity 150 to hold the sensor element 160 a distance from the electrolyte 130 disposed within the housing 105 of the battery cell 100. The threaded hole 155 can couple with the sensor element 160 to seal the battery cell 100 to prevent leakage, for example, from the electrolyte 130. The threaded hole 155 can couple with the sensor element 160 to from an air tight seal the battery cell 100 to prevent residual air, oxygen, or moisture from entering the battery cell 100. For example, the seal formed between the sensor element 160 and the threaded hole 155, can include any type of mechanical seal, such as a hermetic seal, an induction seal, a hydrostatic seal, a hydrodynamic seal, and a bonded seal, among others.

FIG. 6 depicts a cross-section view 600 of a battery pack 605 to hold at least one battery cell 100 and a plurality of battery cells 610. For example, the battery pack 605 can include different types of battery cells, such as two battery cells 100 and a plurality of battery cells 610. The battery cells 100 can include measurement battery cells having at least one sensor element 160 disposed within an extended portion 145 of a lid 135 of the respective battery cells 100. The battery cells 610 may not include a sensor element 160. For example, the battery cells 100 and the battery cells 610 can include at least one electrolyte 130 disposed within a housing 105 of the respective battery cells 100 or battery cells 610. However, the battery cells 100 can be used to obtain reading and provide measurements, via the sensor element 160, for each of the battery cells 100 or battery cells 610 disposed within a respective battery pack 605.

The battery cell 100 can be disposed in a battery pack 605 having multiple battery cells 100 or multiple battery cells 610. The battery cell 100 can provide measurements for the battery pack 605 corresponding to properties of one or more battery cells 100 or one or more battery cells 610 of the multiple battery cells in the battery pack 605 using at least one sensor element 160. The battery cell 100 can be disposed in a battery pack 605 having multiple battery cells 100 or multiple battery cells 610. A battery monitoring unit 615 (e.g., data acquisition system) can couple with the battery cell 100 through the sensor element 160 to receive sensor data. The battery monitoring unit 615 can be external to the battery pack 605 and monitor and obtain measurements on the battery cells 100, 610 or the battery pack 605. The battery monitoring unit 615 can be a component of the battery pack 605 and couple with an external data acquisition system of the electric vehicle to monitor and provide measurements on the battery cells 100, 610 or the battery pack 605. The battery monitoring unit 615 can measures properties of the of one or more of the multiple battery cells 100 or one or more battery cells 610 in the battery pack 605 using the sensor data from the sensor element 160. For example, the sensor element 160 can include a transducer, a thermocouple, a composition sensor, or a flow meter. Thus, the battery monitoring unit 615 can collect data such as, but not limited to, pressure data, temperature data, composition data (e.g., composition of components of an electrolyte 130), or flow data. The battery monitoring unit 615 can couple with the battery cell 100 though the lid 135, via the sensor element 160, to take and provide measurements for properties of components of the battery cell 100 or battery pack 605 in a non-invasive manner. For example, the sensor element (e.g., sensor wire 205, sensor 215) device or sensor wire can couple with the battery monitoring unit 615 through the extended portion 145 of the lid 135. Thus, measurements of internal variables or components of the battery cell 100 or battery pack 605 can be taken without puncturing a hole through the battery cell 100, drilling a hole through the battery cell 100, or other forms of damaging the integrity of the battery cell 100. The threaded hole 155 of the extended portion 145 can provide a port or a feedthrough for one or more sensor elements 160 (e.g., thermocouples, transducers, flow meters) that can couple with or be plugged into the battery monitoring unit 615 (e.g., appropriate data acquisition(DAQ) system) and allow internal variables of the battery cell 100 to be measured. For example, the internal variables can be measured during the cell formation process wherein the solid electrolyte interphase (SEI) is first formed or during operation of the battery cell 100, such as in an electric vehicle.

The battery pack 605 can include a single battery cell 100 having a sensor element 160 and one or more battery cells 610 not having a sensor element 160. The battery pack 605 can include multiple battery cells 100 having a sensor element 160 and multiple battery cells 610 not having a sensor element 160. For example, the one or more battery cells 100 having a sensor element 160 can be disposed at different regions or portions of the battery pack 605 to obtain readings on different groupings of battery cells 100, 610 or different regions of the battery pack 605. Thus, the one or more battery cells 100 having a sensor element 160 can be used to provide sensor data and measurements corresponding to the operation of the battery pack 605 or battery cells 100, 610 within the battery pack 605 during cell formation (e.g., cell formation, battery pack testing) or during operation of an electric vehicle having the battery pack 605. The one or more battery cells 100 having a sensor element 160 can provide a port to couple or plug into different types of sensors or measurement devices to monitor the health of the battery cells 100, 610 or the battery pack 605. For example, the one or more battery cells 100 having a sensor element 160 can be disposed at an edge region of the battery pack 605 with one or battery cells 610 not having a sensor element 160 disposed near or around the battery cells 100. The one or more battery cells 100 having a sensor element 160 can be disposed in a middle region of the battery pack 605 with one or battery cells 610 not having a sensor element 160 disposed near or around the battery cells 100. If the battery pack 605 includes multiple battery cells 100 having at least one sensor element 160, the different battery cells 100 can be disposed at different regions of the battery pack 605 to obtain measurements. For example, a first battery cell 100 having at least one sensor element 160 can be disposed in a first region (e.g., edge region, middle region, first half) of the battery pack 605. A second battery cell 100 having at least one sensor element 160 can be disposed in a second region (e.g., edge region, middle region, second half) of the battery pack 605. The second region of the battery pack 605 can be different from the first region. The different battery cells 100 having at least one sensor element 160 can be spaced equidistant from each other within the battery pack 605. The first battery cell 100 having at least one sensor element 160 can include a first type of sensor element 160 and the second battery cell 100 having at least one sensor element 160 can include a second type of sensor element 160. The first type of sensor element 160 can be a different type of sensor as compared to the second type of sensor element 160 can obtain or collect different type of measurements or properties of battery cells 100, 610 or the battery pack 605. Thus, multiple battery cells 100 having at least one sensor element 160 can be used within the battery pack 605 to monitor and provide measurements of different types of data (e.g., pressure data, temperature data, composition data, flow data) during formation or operation of the battery cells 100, 610 or the battery pack 605.

The battery cells 100, 610 can have an operating voltage in a range from 2.5 V to 5 V (e.g., 2.5 V to 4.2 V). The operating voltage of the battery cell 100, 610 can vary within or outside this range. The battery pack 605 can include a battery case 620 and a capping element 625. The battery case 620 can be separated from the capping element 625. The battery case 620 can include or define a plurality of holders 630. Each holder 630 can include a hollowing or a hollow portion defined by the battery case 620. Each holder 630 can house, contain, store, or hold a battery cell 100, 610. The battery case 620 can include at least one electrically or thermally conductive material, or combinations thereof. The battery case 620 can include one or more thermoelectric heat pumps. Each thermoelectric heat pump can be thermally coupled directly or indirectly to a battery cell 100, 610 housed in the holder 630. Each thermoelectric heat pump can regulate temperature or heat radiating from the battery cell 100, 610 housed in the holder 630. The first bonding element 665 and the second bonding element 670 can extend from the battery cell 100, 610 through the respective holder 630 of the battery case 620. For example, the first bonding element 665 or the second bonding element 670 can couple with the base portion 140, extended portion 145 or housing 105.

Between the battery case 620 and the capping element 625, the battery pack 605 can include a first busbar 635, a second busbar 640, and an electrically insulating layer 645. The first busbar 635 and the second busbar 640 can each include an electrically conductive material to provide electrical power to other electrical components in the electric vehicle. The first busbar 635 (sometimes referred to herein as a first current collector) can be connected or otherwise electrically coupled to the first bonding element 665 extending from each battery cell 100, 610 housed in the plurality of holders 630 via a bonding element 650. The bonding element 650 can include electrically conductive material, such as but not limited to, a metallic material, aluminum, or an aluminum alloy with copper. The bonding element 650 can extend from the first busbar 635 to the first bonding element 665 extending from each battery cell 100, 610. The bonding element 650 can be bonded, welded, connected, attached, or otherwise electrically coupled to the first bonding element 665 extending from the battery cell 100, 610. The first bonding element 665 can define the first polarity terminal for the battery cell 100, 610. The first bonding element 665 can include a first end coupled with a surface of the lid 135 (e.g., base portion 140, extended portion 145) and a second end coupled with a surface of the bonding element 650. The first busbar 635 can define the first polarity terminal for the battery pack 605. The second busbar 640 (sometimes referred to as a second current collector) can be connected or otherwise electrically coupled to the second bonding element 670 extending from each battery cell 100, 610 housed in the plurality of holders 630 via a bonding element 655. The bonding element 655 can include electrically conductive material, such as but not limited to, a metallic material, aluminum, or an aluminum alloy with copper. The bonding element 655 can extends from the second busbar 640 to the second bonding element 670 extending from each battery cell 100, 610. The bonding element 655 can be bonded, welded, connected, attached, or otherwise electrically coupled to the second bonding element 670 extending from the battery cell 100, 610. The second bonding element 670 can define the second polarity terminal for the battery cell 100. The second bonding element 670 can include a first end coupled with a surface of the lid 135 (e.g., base portion 140, extended portion 145) and a second end coupled with a surface of the bonding element 655. The second busbar 640 can define the second polarity terminal for the battery pack 605.

The first busbar 635 and the second busbar 640 can be separated from each other by the electrically insulating layer 645. The electrically insulating layer 645 can include any electrically insulating material or dielectric material, such as air, nitrogen, sulfur hexafluoride (SF6), porcelain, glass, and plastic (e.g., polysiloxane), among others to separate the first busbar 635 from the second busbar 640. The electrically insulating layer 645 can include spacing to pass or fit the first bonding element 665 connected to the first busbar 635 and the second bonding element 670 connected to the second busbar 640. The electrically insulating layer 645 can partially or fully span the volume defined by the battery case 620 and the capping element 625. A top plane of the electrically insulating layer 645 can be in contact or be flush with a bottom plane of the capping element 625. A bottom plane of the electrically insulating layer 645 can be in contact or be flush with a top plane of the battery case 620.

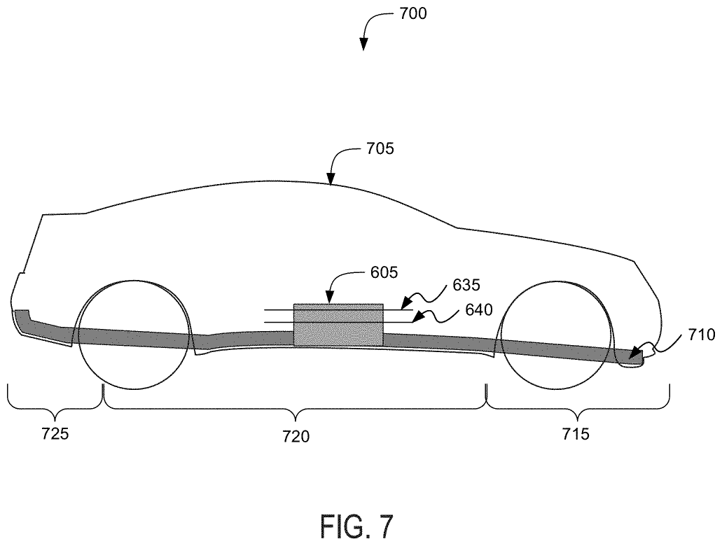

FIG. 7 depicts a cross-section view 700 of an electric vehicle 705 installed with a battery pack 605. The battery pack 605 can include at least one battery cell 100 having a sensor element 160. The battery pack 605 can include at least one battery cell 100 having a sensor element 160 and at least one battery cell 610 not having a sensor element 160. For example, the battery pack 605 can include at least one battery cell 100 having a sensor element 160 to obtain measurements and sensor data corresponding to one or more battery cells 100, 610 in the respective battery pack 605. The battery cells 100, 610 described herein can be used to form battery packs 605 residing in electric vehicles 705 for an automotive configuration. For example, the battery cell 100, 610 can be disposed in the battery pack 605 and the battery pack 605 can be disposed in the electric vehicle 705. An automotive configuration includes a configuration, arrangement or network of electrical, electronic, mechanical or electromechanical devices within a vehicle of any type. An automotive configuration can include battery cells for battery packs in vehicles such as electric vehicles (EVs). EV s can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned. Thus, the electric vehicle 705 can include an autonomous, semi-autonomous, or non-autonomous human operated vehicle. The electric vehicle 705 can include a hybrid vehicle that operates from on-board electric sources and from gasoline or other power sources. The electric vehicle 705 can include automobiles, cars, trucks, passenger vehicles, industrial vehicles, motorcycles, and other transport vehicles. The electric vehicle 705 can include a chassis 710 (sometimes referred to herein as a frame, internal frame, or support structure). The chassis 710 can support various components of the electric vehicle 705. The chassis 710 can span a front portion 715 (sometimes referred to herein a hood or bonnet portion), a body portion 720, and a rear portion 725 (sometimes referred to herein as a trunk portion) of the electric vehicle 705. The front portion 715 can include the portion of the electric vehicle 705 from the front bumper to the front wheel well of the electric vehicle 705. The body portion 720 can include the portion of the electric vehicle 705 from the front wheel well to the back wheel well of the electric vehicle 705. The rear portion 725 can include the portion of the electric vehicle 705 from the back wheel well to the back bumper of the electric vehicle 705.

The battery pack 605 that includes at least one battery cell 100 having a sensor element 160 can be installed or placed within the electric vehicle 705. For example, the battery pack 605 can couple with a drive train unit of the electric vehicle 705. The drive train unit may include components of the electric vehicle 705 that generate or provide power to drive the wheels or move the electric vehicle 705. The drive train unit can be a component of an electric vehicle drive system. The electric vehicle drive system can transmit or provide power to different components of the electric vehicle 705. For example, the electric vehicle drive train system can transmit power from the battery pack 605 to an axle or wheels of the electric vehicle 705. The battery pack 605 can be installed on the chassis 710 of the electric vehicle 705 within the front portion 715, the body portion 720 (as depicted in FIG. 7), or the rear portion 725. A first busbar 635 (e.g., first polarity busbar) and a second busbar 640 (e.g., second polarity busbar) can be connected or otherwise be electrically coupled with other electrical components of the electric vehicle 705 to provide electrical power from the battery pack 605 to the other electrical components of the electric vehicle 705. For example, the first busbar 635 can couple with at least one surface of a battery cell 100, 610 (e.g., lid 135, housing 105) of the battery pack 605 through a wirebond or bonding element (e.g., bonding element 650 of FIG. 6). The second busbar 640 can couple with at least one surface of a battery cell 100, 610 (e.g., lid 135, housing 105) of the battery pack 605 through a wirebond or bonding element (e.g., bonding element 655 of FIG. 6).

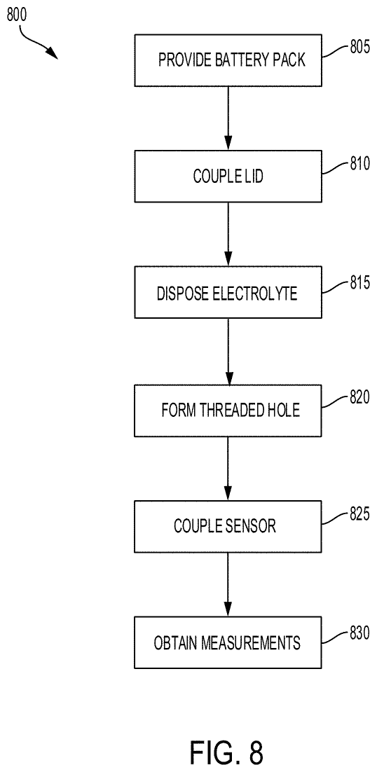

FIG. 8, among others, depicts a flow diagram of a method 800 of providing a battery cell 100 of a battery pack 605 to power an electric vehicle 705. The method 800 can include providing a battery pack 605 (ACT 805). For example, the method 800 can include providing a battery pack 605 having a battery cell 100. The battery cell 100 can include a housing 105 that includes a first end 110 and a second end 115. The housing 105 can be formed having or defining an inner region 120. The battery cell 100 can be a lithium ion battery cell, a nickel-cadmium battery cell, or a nickel-metal hydride battery cell. The battery cell 100 can be part of a battery pack 605 installed within a chassis 710 of an electric vehicle 705. For example, the battery cell 100 can be one of multiple battery cells 100 disposed within a battery pack 605 of the electric vehicle 705 to power the electric vehicle 705. The housing 105 can be formed from a cylindrical casing with a circular, ovular, elliptical, rectangular, or square base or from a prismatic casing with a polygonal base.

The method 800 can include coupling a lid 135 (ACT 810). For example, the method 800 can include coupling a lid 135 with the first end 110 of the housing 105. The lid 135 can be formed having a base portion 140 and an extended portion 145. The extended portion 145 can be an extension of the base portion 140. The extended portion 145 can be coupled with or welded with the base portion 140 to form the lid 135. Coupling the lid 135 can include forming a crimped edge 310 on the base portion 140 of the lid 135. For example, an edge surface or outer surface of the base portion 140 can be crimped, bent, or otherwise manipulated to form over at least one surface (e.g., top surface) of the first end 110 of the housing 105. The crimped edge 310 can contact and couple with at least one surface of the first end 110 of the housing 105 to seal the battery cell 100. For example, the crimped edge 310 can be formed such that a portion of the crimped edge 310 couples with an indentation 125 of the first end 110. The indentation 125 can include a groove or deformation formed into the first end 110 of the housing 105 to receive the crimped edge 310. At least one edge portion or end portion of the base portion 140 that has been crimped, bent, or otherwise manipulated can be formed such that a portion of the crimped edge 310 can be crimped into the indentation 125 of the first end 110 to couple the lid 135 with the housing 105. The crimped edge 310 can be crimped onto, clipped onto, or welded with the indentation 125 to couple the lid 135 with the first end 110 of the housing 105. The seal formed by the crimped edge 310, between the lid 135 and the first end 110 of the housing 105, can include any type of mechanical seal, such as a hermetic seal, an induction seal, a hydrostatic seal, a hydrodynamic seal, and a bonded seal, among others.

The method 800 can include disposing an electrolyte 130 (ACT 815). For example, method 800 can include disposing an electrolyte 130 in the inner region 120 defined by the housing 105. The electrolyte 130 can be disposed in the inner region 120 defined by the housing 105 of the battery cell 100. A single electrolyte 130 can be disposed within the inner region 120 or multiple electrolytes 130 (e.g., two or more) can be disposed within the inner region 120. The electrolytes 130 can be positioned within the inner region 120 such that they are spaced evenly from each other. For example, the electrolytes 130 can be positioned within the inner region 120 such that they are not in contact with each other. One or more insulation materials 165 may be disposed between different electrolytes 130 within the same or common inner region 120. The electrolytes 130 can be positioned within the inner region 120 such that they are spaced a predetermined distance from an inner surface of the housing 105. For example, insulation materials 165 may be disposed between different inner surfaces of the housing 105 and the electrolytes 130 within the inner region 120 to insulate the housing 105 from the electrolytes 130. Thus, a distance the electrolytes 130 are spaced from the inner surface of the housing 105 can correspond to a thickness of the insulation materials 165. An insulation material 165 can electrically insulate portions or surfaces of a lid 135 from the electrolyte 130. The insulation material 165 can be disposed over a top surface of the electrolyte 130 such that the insulation material 165 is disposed between the electrolyte 130 and portions of the lid 135.

The method 800 can include forming a threaded hole 155 (ACT 820). For example, a threaded hole 155 can be formed or coupled with an inner cavity 150 of the extended portion 145. The extended portion 145 can be formed as a hollow portion of the lid 135 having an inner cavity 150. The threaded hole 155 can form an opening, a port or be part of an opening of the inner cavity 150. Forming the threaded hole 155 can include forming a threaded surface or pattern surface on an inner surface of the inner cavity 150. Forming the threaded hole 155 can include forming a series of raised surfaces or a pattern of raised surfaces (e.g., corkscrew pattern) to form a threaded inner surface 305. Forming the threaded hole 155 can include forming a continuous raised surface that wraps around or extends around the inner surface of the threaded hole 155. Forming the threaded hole 155 can include forming a ridge or uniform section in the form of a helix on the internal surface of threaded hole 155, or in the form of a conical spiral on the internal surface of the threaded hole 155. Forming the threaded hole 155 can include forming a series of notches or connection points to couple with indentations or connection points formed on an outer surface of a sensor element 160 (e.g., sensor wire 205, sensor 215). The threaded hole 155 can be formed into an inner surface of the inner cavity 150. The threaded hole 155 can be a separate component from the inner cavity 150 of the extended portion 145. For example, the threaded hole 155 can be disposed within the inner cavity 150. The threaded hole 155 can couple with or welded to an inner surface of the inner cavity 150. The threaded hole 155 can be formed at a bottom region or bottom portion of the inner cavity 150. The threaded hole 155 can be formed at a middle region or middle portion (e.g., as shown in FIG. 1) of the inner cavity 150. The threaded hole 155 can be formed at a top region or top portion of the inner cavity 150. The inner cavity 150 may include a threaded hole 155 or threaded inner surface formed an entire length (e.g., top to bottom) of an inner surface of the inner cavity 150. The threaded hole 155 can have a circular, ovular, elliptical, rectangular, or square shape. The shape of the threaded hole 155 can correspond to the shape of the inner cavity 150.

The method 800 can include coupling a sensor element 160 (ACT 825). For example, the method 800 can include coupling a sensor element 160 with a threaded hole 155 of the extended portion 145 of the lid 135 to form a hermetic seal and a fluid resistant seal for the battery cell 100. The sensor element 160 can be disposed within the inner cavity 150 of the extended portion 145. Coupling the sensor element 160 can include coupling a threaded outer surface of the sensor element 160 with the threaded inner surface 305 of the threaded hole 155. For example, a threaded outer surface of the sensor element 160 can screw into the threaded hole 155 to couple the sensor element 160 within the inner cavity 150 of the extended portion 145. Coupling the sensor element 160 can include coupling a connector to an outer surface of the sensor element 160. The connector can couple with the threaded hole 155 to couple the sensor element 160 with the threaded hole 155. For example, a connector (e.g., brass fitting, fastener) can couple with at least one surface of the sensor element 160 and couple with at least one surface of the threaded hole 155 to couple the sensor element 160 with the threaded hole 155.

The sensor element 160 can include a sensor wire 205 or a sensor 215. For example, coupling the sensor element 160 can include coupling a connector to an outer surface of the sensor wire 205. For example, a connector (e.g., brass fitting, fastener) can couple with at least one surface of the sensor wire 205 and couple with at least one surface of the threaded hole 155 to couple the sensor wire 205 with the threaded hole 155. Coupling the sensor element 160 can include coupling a connector to an outer surface of the sensor 215. For example, a connector (e.g., brass fitting, fastener) can couple with at least one surface of the sensor 215 and couple with at least one surface of the threaded hole 155 to couple the sensor 215 with the threaded hole 155. Coupling the sensor element 160 can include coupling the sensor wire 205 with the sensor 215. For example, the sensor wire 205 can include a first end 207 that extends out of the extended portion 145. The first end 207 can provide a connection point to couple with a battery monitoring unit 615 or other form of an external sensor to provide readings or measurements corresponding to the battery cell 100. The sensor wire 205 can include a second end 209 that couples with the sensor 215 within a column region 220 of the inner region 120 of the housing 105.

The method 800 can include obtaining measurements (ACT 830). For example, the method 800 can include measuring one or more properties of the battery cell 100 or battery pack 605 using the sensor element 160. The properties can include, but not limited to, a pressure value, a temperature value, a composition value, or a flow value. Obtaining measurements of the battery cell 100 or battery pack 605 can include coupling at least one battery cell 100 having a sensor element 160 with a battery monitoring unit 615. Obtaining measurements can include disposing a single battery cell 100 having a sensor element 160 and one or more battery cells 610 not having a sensor element 160 in a battery pack 605. Multiple battery cells 100 having a sensor element 160 and multiple battery cells 610 not having a sensor element 160 can be disposed in a battery pack 605. The one or more battery cells 100 having a sensor element 160 can be disposed at an edge region of the battery pack 605. The one or more battery cells 100 having a sensor element 160 can be disposed in a middle region of the battery pack 605. If the battery pack 605 includes multiple battery cells 100 having at least one sensor element 160, the different battery cells 100 can be disposed at different regions of the battery pack 605 to obtain measurements. For example, obtaining measurements can include disposing a first battery cell 100 having at least one sensor element 160 in a first region (e.g., edge region, middle region, first half) of the battery pack 605. Obtaining measurements can include disposing a first battery cell 100 having at least one sensor element 160 in a second region (e.g., edge region, middle region, second half) of the battery pack 605. The second region of the battery pack 605 can be different from the first region. The different battery cells 100 having at least one sensor element 160 can be spaced equidistant from each other within the battery pack 605.

Obtaining measurements can include the battery monitoring unit 615 coupling with at least one battery cell 100 through at least one sensor element 160 to receive sensor data. The battery monitoring unit 615 can measures properties of the of one or more of the multiple battery cells 100 or one or more battery cells 610 in the battery pack 605 using the sensor data from the sensor element 160. For example, obtaining measurements can include transmitting a request for sensor data from the battery monitoring unit 615 to at least one battery cell 100 having at least one sensor element 160. Obtaining measurements can include receiving sensor data at the battery monitoring unit 615 from at least one battery cell 100 having at least one sensor element 160. The sensor data can include, but not limited to, pressure data, temperature data, composition data (e.g., composition of components of an electrolyte 130), or flow data. The sensor data can correspond to properties of the battery pack 605 having the battery cell 100 having the at least one sensor element 160 providing the sensor data. The sensor data can correspond to properties of one or more battery cells 100, 610 disposed next to the battery cell 100 having the at least one sensor element 160 providing the sensor data. The sensor data can correspond to properties of the battery cell 100 having the at least one sensor element 160 and providing the sensor data.

The battery monitoring unit 615 can couple with the battery cell 100 though the lid 135, via the sensor element 160, to take and provide measurements for properties of components of the battery cell 100 or battery pack 605 in a non-invasive manner. For example, the sensor element (e.g., sensor wire 205, sensor 215) device or sensor wire can couple with the battery monitoring unit 615 through the extended portion 145 of the lid 135. Thus, measurements of internal variables or components of the battery cell 100 or battery pack 605 can be taken without puncturing a hole through the battery cell 100, drilling a hole through the battery cell 100, or other forms of damaging the integrity of the battery cell 100.

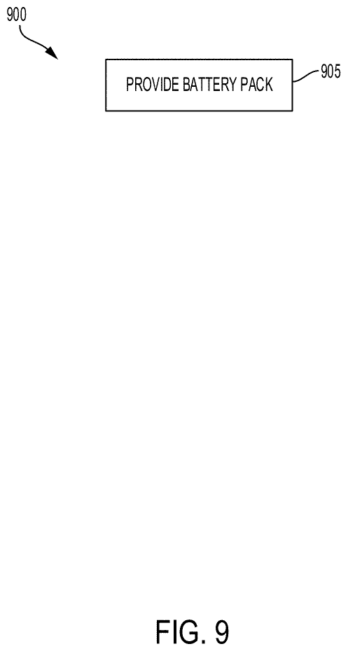

FIG. 9 depicts a method 900. The method 900 can include providing a battery pack 605 having at least one battery cell 100 for electric vehicles 705 (ACT 905). The battery pack 605 can include at least one battery cell 100. The battery cell 100 can include a housing 105 having a first end 110 and a second end 115. The housing 105 can define an inner region 120. An electrolyte 130 can be disposed in the inner region 120 defined by the housing 105. A lid 135 can couple with a first end 110 of the housing 105. The lid 135 can include a base portion 140 coupled with the first end 110 of the housing 105. The lid 135 can include an extended portion 145 coupled with the base portion 140. The extended portion 145 can include an inner cavity 150. The extended portion 145 can include a threaded hole 155 forming an opening of the inner cavity 150. A sensor element 160 can couple with the threaded hole 155 of the extended portion 145. The sensor element 160 can be disposed within the inner cavity 150 of the extended portion 145.

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example the voltage across terminals of battery cells can be greater than 5V. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A battery cell of a battery pack to power an electric vehicle, the battery cell comprising:
a housing having a first end and a second end, the housing defining an inner region;
an electrolyte disposed in the inner region defined by the housing; and
a lid coupled with a first end of the housing, the lid comprising:
a base portion coupled with the first end of the housing; and
an extended portion coupled with the base portion, the extended portion comprising:
an inner cavity; and
a threaded hole forming an opening of the inner cavity;
a sensor element coupled with the threaded hole of the extended portion, the sensor element disposed within the inner cavity of the extended portion.

2. The battery cell of claim 1, comprising:
the sensor element including at least one of: a sensor coupled with the threaded hole of the extended portion or a sensor wire coupled with the threaded hole of the extended portion.

3. The battery cell of claim 1, comprising:
the sensor element including a sensor and a sensor wire;
the sensor wire coupled with the threaded hole of the extended portion; and
the sensor coupled with the sensor wire, and the sensor disposed within the inner cavity of the extended portion of the lid.

4. The battery cell of claim 1, comprising:
a connector disposed between the threaded hole of the extended portion and the sensor element;
the connector coupled with the threaded hole of the extended portion; and
the connector coupled with the sensor element to couple the sensor element with the threaded hole of the extended portion of the lid.

5. The battery cell of claim 1, comprising:
a connector coupled with the extended portion, the connector disposed between the threaded hole of the extended portion and the sensor element; and
a sealing agent disposed between the connector and the threaded hole of the extended portion, the sealing agent forms a hermetic seal and a fluid resistant seal between the connector and the threaded hold of the extended portion.

6. The battery cell of claim 1, comprising:
the lid having a first threaded hole and a second threaded hole;
a first sensor coupled with the first threaded hole; and
a second sensor coupled with the second threaded hole, the first sensor different from the second sensor, and the first sensor collects different measurements corresponding to the battery cell from the second sensor.

7. The battery cell of claim 1, comprising:
the sensor element comprising at least one of: a transducer, a thermocouple, a composition sensor, or a flow meter.

8. The battery cell of claim 1, comprising:
the extended portion having a first height; and
the base portion having a second height, the first height greater than the second height with respect to a first surface of the first end of the housing.

9. The battery cell of claim 1, comprising:
the extended portion having a first diameter; and
the base portion having a second diameter, the first diameter different than the second diameter.

10. The battery cell of claim 1, comprising:
the sensor element disposed a predetermined distance from a first surface of the electrolyte within the battery cell.

11. The battery cell of claim 1, comprising:
a column region extending from the inner cavity of the lid into the inner region of the housing; and
the sensor element disposed within the column region within the inner region of the housing.

12. The battery cell of claim 1, comprising:
a battery monitoring unit coupled with the battery cell through the sensor element to receive sensor data;
the battery monitoring unit measures one or more properties of the battery cell using the sensor data from the sensor element.

13. The battery cell of claim 1, comprising:
the first end of the housing having an indentation; and
the base portion of the lid coupled with the indentation of the first end of the housing.

14. The battery cell of claim 1, comprising:
a connector coupling the base portion with the first end of the housing.

15. The battery cell of claim 1, comprising:
the battery cell disposed in a battery pack having multiple battery cells, the battery cell providing measurements for the battery pack corresponding to properties of one or more battery cells of the multiple battery cells in the battery pack.

16. The battery cell of claim 1, comprising:
the battery cell disposed in a battery pack having multiple battery cells; and
a battery monitoring unit coupled with the battery cell through the sensor element to receive sensor data, the battery monitoring unit measures properties of the of one or more of the multiple battery cells in the battery pack using the sensor data from the sensor element.

17. The battery cell of claim 1, comprising:
the battery cell disposed in a battery pack and the battery pack disposed in an electric vehicle.

18. A method of providing a battery cell of a battery pack to power an electric vehicle, the method comprising:
providing a battery pack having a battery cell, the battery cell having a housing that includes a first end and a second end and defines an inner region;
coupling a lid with the first end of the housing, the lid having a base portion and an extended portion;
disposing an electrolyte within the inner region defined by the housing; and
coupling a sensor element with a threaded hole of the extended portion of the lid to form a hermetic seal and a fluid resistant seal for the battery cell, the sensor element disposed within the inner cavity of the extended portion.

19. The method of claim 18, comprising:
measuring one or more properties of the battery cell using the sensor element, the properties including at least one of: a pressure value, a temperature value, a composition value, or a flow value.

20. An electric vehicle, comprising:
a battery pack having a battery cell, the battery cell comprising:
a housing having a first end and a second end, the housing defining an inner region;
an electrolyte disposed in the inner region defined by the housing; and
a lid coupled with a first end of the housing, the lid comprising:
a base portion coupled with the first end of the housing; and
an extended portion coupled with the base portion, the extended portion comprising:
an inner cavity; and
a threaded hole forming an opening of the inner cavity;
a sensor element coupled with the threaded hole of the extended portion, the sensor element disposed within the inner cavity of the extended portion.
